(19) United States
(12) Patent Application Publication
(10) Pub. No.: US 2008/0075005 A1
(43) Pub. Date: Mar. 27, 2008

(54) DATA TRANSMISSION METHOD INDICATING DATA PENDING IN ZIGBEE NETWORK

(75) Inventors: Ji Hoon KIM, Gyunggi-do (KR); Seung Han Ko, Gyunggi-do (KR); Bo II Seo, Seoul (KR); Koon Shik Cho, Seoul (KR); Sang Hyun Sim, Seoul (KR); Soon Jin Choi, Gyunggi-do (KR); Chung Hee Lee, Gyunggi-do (KR)

Correspondence Address: LOWE HAUPTMAN HAM & BERNER, LLP, 1700 DIAGONAL ROAD, SUITE 300, ALEXANDRIA, VA, 22314, US

(73) Assignee: SAMSUNG ELECTRO-MECHANICS CO., LTD., Gyunggi-do (KR)

(21) Appl. No.: 11/860,324

(22) Filed: Sep. 24, 2007

(30) Foreign Application Priority Data
Sep. 25, 2006 (KR) 10-2006-0092748

(51) Int. Cl. G08C 15/00

(52) U.S. Cl. 370/230

(57) ABSTRACT

A data transmission method indicating data pending in a ZigBee network is provided, wherein the data transmission method is used to shorten a delay time for data transmission by setting a certain bit to indicate data pending in the ZigBee network to a ZigBee device, the certain bit indicating data pending to an acknowledge frame for acknowledging a data frame from the ZigBee device. The data transmission method according to the present invention includes broadcasting beacons so as to allow the ZigBee coordinator to maintain the connection of the ZigBee network; downloading a data frame from an assigned ZigBee device transmitting the data frame by receiving the beacons; and transmitting an acknowledge frame including a data pending bit indicating data pending to the assigned ZigBee device.

### CROSS-REFERENCE TO RELATED APPLICATIONS

This application claims the priority of Korean Patent Application No. 2006-0092748 filed on Sep. 25, 2006, in the Korean Intellectual Property Office, the disclosure of which is incorporated herein by reference.

### BACKGROUND OF THE INVENTION

1. Field of the Invention

The present invention relates to a data transmission method indicating data pending in a ZigBee network, and more particularly, to a data transmission method indicating data pending in a ZigBee network, the data transmission method capable of shortening a delay time for data transmission by setting a certain bit to indicate data pending in the ZigBee network to a ZigBee device, the certain bit indicating data pending to an acknowledge frame for acknowledging a data frame from the ZigBee device.

2. Description of the Related Art

In general, ZigBee refers to an IEEE802.15.4 low-rate wireless personal area network (LR-WPAN), and also a system that performs telecommunications by dividing a frequency band into three sub-bands and setting data rates to a different level from a spreading method in each of the frequency bands.

Such the ZigBee is directed to small and inexpensive articles which are low in power consumption, and has been increasingly used as a ubiquitous computing technique in wireless local area network markets such as homes, offices, etc., a distance of which is in a range from 10 to 20 m.

FIG. 1 is a block diagram illustrating a schematic configuration of a conventional ZigBee network.

Referring to FIG. 1, a conventional ZigBee network 10 is composed of a ZigBee coordinator (ZC) 11 administering a network; and at least one ZigBee device (ZD) 12a, 12b, 12c, 12d connected to the ZigBee coordinator 11 to perform a predetermined operation. The ZigBee network 10 may further include a ZigBee router that functions in part as the ZigBee coordinator, when necessary.

The ZigBee coordinator 11 and the ZigBee device 12a through 12d, all of which are included in the ZigBee network 10, transmit and receive a predetermined signal according to an IEEE 802.15.4 standard. The transmitted/received signal may be typically a data frame. Accordingly, the data transmission method will be described in detail with reference to FIG. 2.

FIG. 2 is a flowchart illustrating a data transmission method in the conventional ZigBee network.

Referring to FIGS. 1 and 2, first, the data transmission method in the conventional ZigBee network broadcasts a predetermined beacon to maintain the connection of the ZigBee coordinator 11 to its adjacent ZigBee devices 12a through 12d (S10).

Therefore, a corresponding ZigBee device (one of the ZigBee devices 12a through 12d) transmits a predetermined data frame to the ZigBee coordinator 11, and the ZigBee coordinator 11 transmits an acknowledge frame (ACK Frame), which corresponds to the data frame, to the corresponding ZigBee device (S20).

Then, the ZigBee coordinator 11 broadcasts a beacon indicating the presence of data that will be transmitted to the ZigBee devices 12a through 12d disposed around the ZigBee coordinator 11 (S30).

As a result, at least one of the corresponding ZigBee devices 12a through 12d transmits a data request frame to the ZigBee coordinator 11, and the ZigBee coordinator 11 sets a certain bit indicating the presence of the transmission data in the ZigBee device that has transmitted the data request frame, and transmits an acknowledge frame (S40).

Then, the ZigBee coordinator 11 transmits a data, which is expected to transmit, to the ZigBee device, and the ZigBee device downloading the data transmits an acknowledge frame corresponding to the data to the ZigBee coordinator 11 (S50). When an additional data to be transmitted remains in the ZigBee coordinator 11, the operations (S30 through S50) are repeated to transmit the data.

In the above-mentioned data transmission method in the conventional ZigBee network, a kind of the beacons that are transmitted from the ZigBee coordinator 11 to the ZigBee device are shown in FIG. 3.

FIG. 3 is a table representing delay times of beacons used in the data transmission method in the conventional ZigBee network.

Referring to FIGS. 1 through 3, the beacons used for the data transmission method in the conventional ZigBee network are divided into beacon levels 0 to 14 according to its use, and their delay times are set to different values.

For example, when the beacon indicating the transmission of data that the ZigBee coordinator 11 transmits is assigned to a beacon level 4, then the corresponding ZigBee device transmits a data request frame indicating a data request after the delay time of 245760 us.

That is to say, the data transmission method in the conventional ZigBee network includes assigning a ZigBee device to which a data will transmit through beacons, and then enabling a certain bit to transmit an acknowledge frame to the corresponding ZigBee device when it receives a data request frame from the corresponding ZigBee device, the enabling of the certain bit meaning that the ZigBee coordinator 11 must prepare for receiving an acknowledge frame since there is data to be transmitted to the acknowledge frame for the data request frame.

Therefore, the conventional data transmission method has a problem that a delay time for the data transmission is unnecessarily long, and power is undesirably consumed in the low power consumption-oriented ZigBee networks due to the long delay time for the data transmission.

### SUMMARY OF THE INVENTION

An aspect of the present invention provides a data transmission method indicating data pending in a ZigBee network, the data transmission method capable of shortening a delay time for data transmission by setting a certain bit to indicate data pending in the ZigBee network to a ZigBee device, the certain bit indicating data pending to an acknowledge frame for acknowledging a data frame from the ZigBee device.

According to an aspect of the present invention, there is provided a data transmission method indicating data pending in a ZigBee network, the data transmission method being used in a ZigBee network including a ZigBee coordinator and at least one ZigBee device connected to the ZigBee coordinator, the data transmission method including broadcasting beacons to allow the ZigBee coordinator to maintain the connection of the ZigBee network; downloading a data frame from an assigned ZigBee device transmitting the data frame by receiving the beacons; and transmitting an acknowledge frame including a data pending bit indicating data pending to the assigned ZigBee device. In addition, the data transmission method according to the present invention may further include downloading a data request frame for requesting data transmission from the assigned ZigBee device and transmitting a data to be transmitted to the assigned ZigBee device when the data to be transmitted to the assigned ZigBee device remains in the ZigBee coordinator.

The acknowledge frame may include a header having a frame control field, and the frame control field may include the data pending bit.

The data frame may be a frame indicating the downloading of the beacons for the connection of the ZigBee network. In addition, the data frame may be a frame including an acknowledge information indicating the downloading of the beacons for the connection of the ZigBee network; and an operation information performing an operation in the ZigBee coordinator to perform a predetermined operation by request of external users.

The data pending bit may be a frame pending bit, and the frame pending bit may be set to a bit value of “1” when a data to be transmitted remains in the ZigBee coordinator and set to a bit value of “0” when a data to be transmitted does not remain.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram illustrating a conventional ZigBee network,

FIG. 2 is a flowchart illustrating a data transmission method in the conventional ZigBee network,

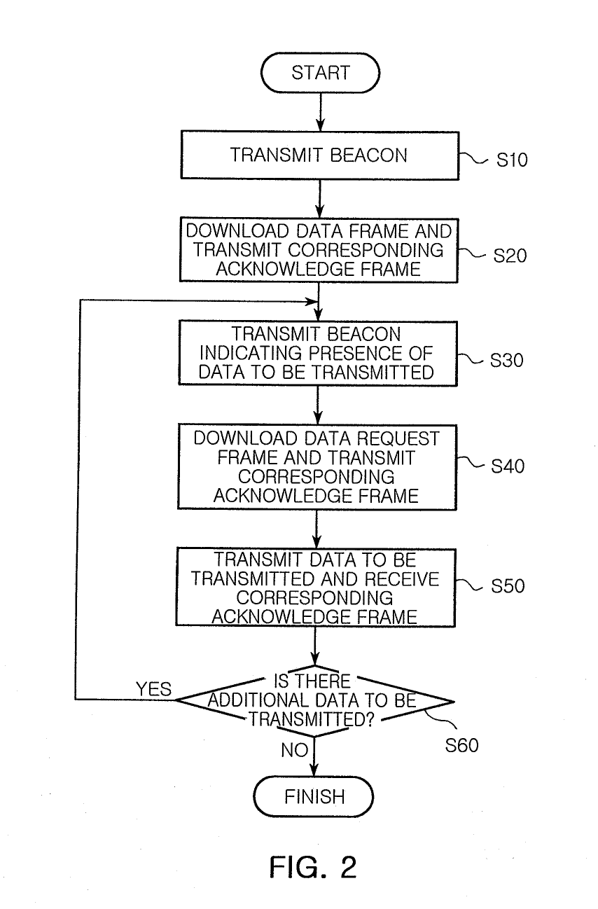

FIG. 3 is a table representing delay times of beacons used in the data transmission method in the conventional ZigBee network,

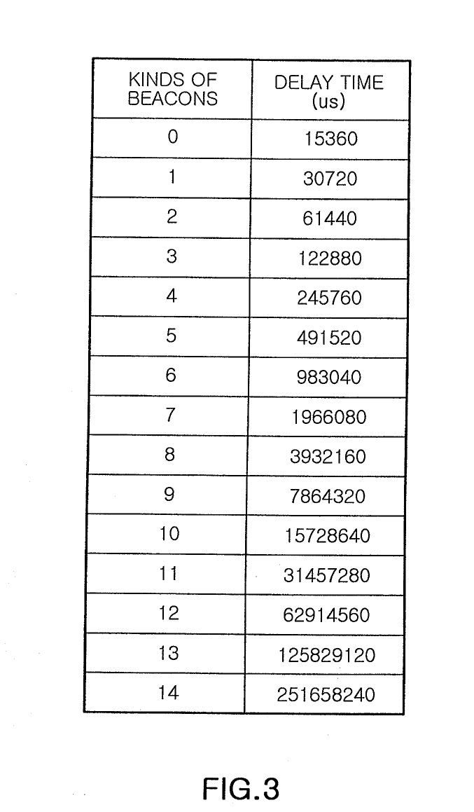

FIG. 4 is a flowchart illustrating a data transmission method in a ZigBee network according to an exemplary embodiment of the present invention,

FIG. 5 is a block diagram illustrating a configuration of a ZigBee unit used in an exemplary embodiment of the present invention,

FIG. 6 is a diagram illustrating an example of employing the data transmission method according to the present invention in a ZigBee network,

FIG. 7 is a block diagram illustrating a configuration of an acknowledge frame used in an exemplary embodiment of the present invention,

FIG. 8A is a block diagram illustrating a transmission/reception packet simulated and captured according to the conventional data transmission method, and

FIG. 8B is a block diagram illustrating a transmission/reception packet simulated and captured according to the data transmission method according to an exemplary embodiment of the present invention.

### DETAILED DESCRIPTION OF THE PREFERRED EMBODIMENT

Exemplary embodiments of the present invention will now be described in detail with reference to the accompanying drawings.

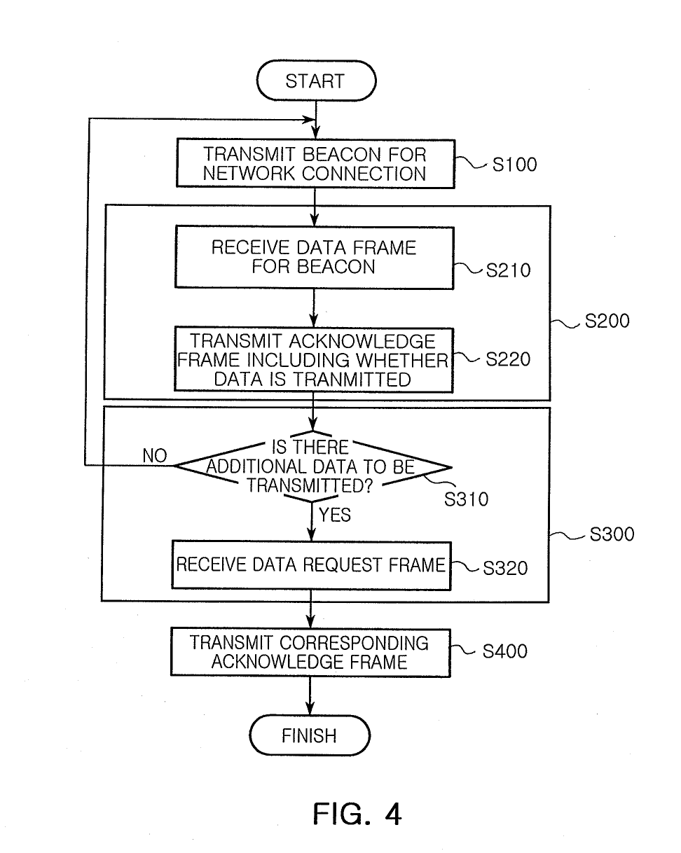

FIG. 4 is a flowchart illustrating a data transmission method in a ZigBee network according to an exemplary embodiment of the present invention.

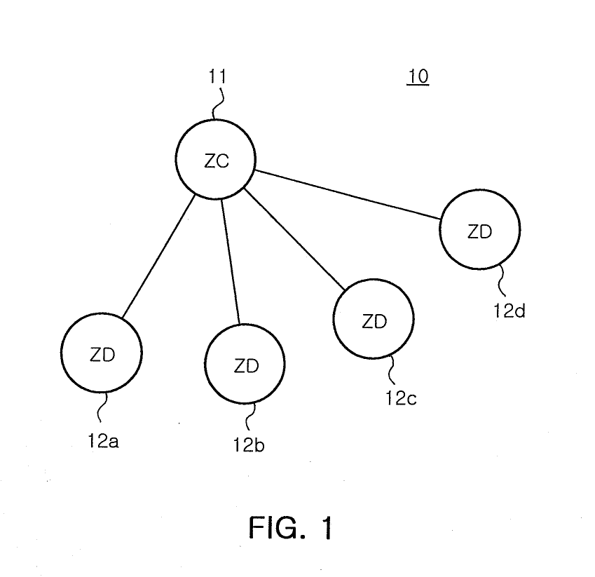

Referring to FIGS. 1 and 4, the data transmission method in the ZigBee network according to an exemplary embodiment of the present invention, first, broadcasts a beacon for network connection from the ZigBee coordinator 11 (S100), the beacon maintaining the network connection of its surrounding ZigBee devices 12a through 12d.

The beacon for network connection is a beacon for confirming whether the surrounding ZigBee devices 12a through 12d maintain the connection to the ZigBee network, or normally operates to the extent that it downloads a data, and has a configuration according to an IEEE 802.15.4 standard.

Then, the ZigBee devices 12a through 12d downloading the beacon for network connection transmit a data frame to the ZigBee coordinator 11 (S210), the data frame corresponding to the beacon for network connection.

The data frame may be an acknowledge frame acknowledging the beacon for network connection, and a data frame including information used for performing a predetermined operation in the ZigBee coordinator 11 to perform the operation by request of the acknowledge frame and external users.

Next, the ZigBee coordinator 11 downloading the data frame transmits an acknowledge frame to the ZigBee device transmitting the data frame, the acknowledge frame indicating the downloading of the data frame.

In this case, when a data to be transmitted afterward remains in the ZigBee device transmitting the data frame, the ZigBee coordinator 11 transmits the data, including a certain bit, to ZigBee device transmitting the data frame, the certain bit indicating that the data to be transmitted remains in the acknowledge frame (S220).

The certain bit may be a bit in an unused field out of various kinds of fields having the acknowledge frame, and preferably a frame pending bit included in a frame control field.

For example, the frame pending bit may be set to a bit value of “0” or “1” since it is composed of one bit, and therefore the frame pending bit may be set to a value of “1” and then transmitted to the ZigBee device that will transmit the data when data to be transmitted remains, whereas the frame pending bit may be set to a bit value of “0” and then transmitted to the ZigBee device when data to be transmitted does not remain.

Then, the ZigBee device downloading the acknowledge frame including the certain bit estimates the certain bit in the acknowledge frame (S310), and recognizes the presence of data to be transmitted from the ZigBee coordinator 11 when the certain bit is “1”, and then transmits a data request frame corresponding to the bit value of “1” to the ZigBee coordinator 11 (S320).

Subsequently, the ZigBee coordinator 11 downloading the data request frame transmits a data, which is expected to transmit, to the ZigBee device that has transmitted the data request frame (S400).

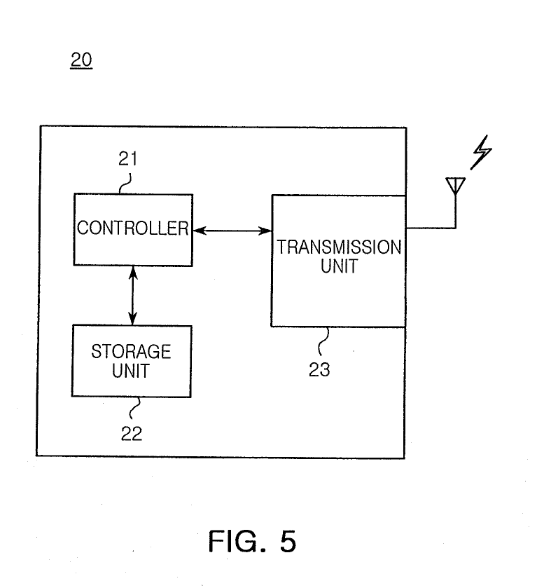

FIG. 5 is a block diagram illustrating a schematic configuration of a ZigBee unit used in the present invention.

Referring to FIG. 5, a ZigBee unit 100 used in the present invention includes a controller 110, a storage unit 120 and a transmission unit 130. Here, the ZigBee unit 100 may be a ZigBee coordinator administering a ZigBee network, and also be a ZigBee device connected to the ZigBee coordinator to form a network.

The controller 110 may be composed of an application layer, a network layer and a MAC layer. Here, some of the MAC layer may be composed of separate hardware.

The storage unit 120 stores address information and transmission data information used in the controller 110, and provides the information through the control of the controller 110.

The transmission unit 130 transmits/receives a predetermined data through the control of the controller 110.

As described above, the ZigBee unit used in the present invention may be used as a ZigBee coordinator and ZigBee devices, which constitute a ZigBee network, and therefore a data transmission method between the ZigBee coordinator and the ZigBee devices according to the present invention will be described in detail.

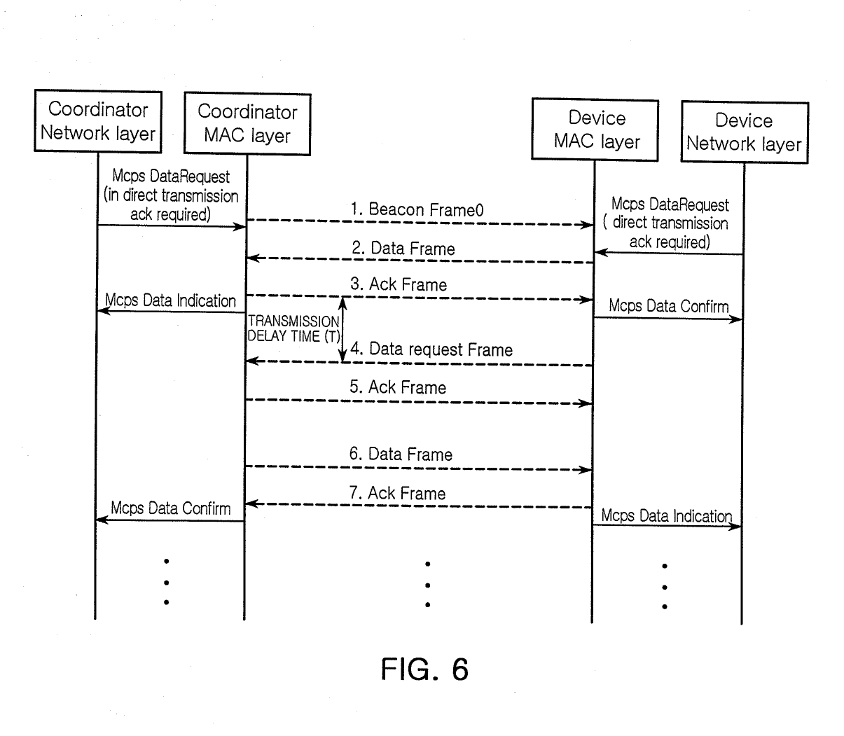

FIG. 6 is a diagram illustrating an example of employing the data transmission method according to an exemplary embodiment of the present invention in a ZigBee network.

Referring to FIGS. 4 through 6, a beacon for network connection is transmitted to a MAC layer of a ZigBee device in a MAC layer of a ZigBee coordinator (S100 of FIG. 4, “1” of FIG. 6).

Then, a network layer of the ZigBee coordinator sends to the MAC layer an Mcps Data Request command indicating that data to be transmitted remains in the ZigBee coordinator. Also, the network layer of the ZigBee device sends to the MAC layer an Mcps Data Request command indicating that a data for the beacon for network connection remains in the ZigBee coordinator, and therefore the MAC layer of the ZigBee device transmits a data frame to the MAC layer of the ZigBee coordinator (S210 of FIG. 4, “2” of FIG. 6).

Subsequently, the MAC layer of the ZigBee coordinator transmits an acknowledge frame corresponding to the data frame. At this time, the MAC layer sets a certain bit of the acknowledge frame to a bit value of “1” and transmits the set acknowledge frame to the ZigBee device when data to be transmitted to the ZigBee device that has transmitted the data frame remains (S300 of FIG. 4, “3” of FIG. 6). A configuration of the acknowledge frame will be described in more detail.

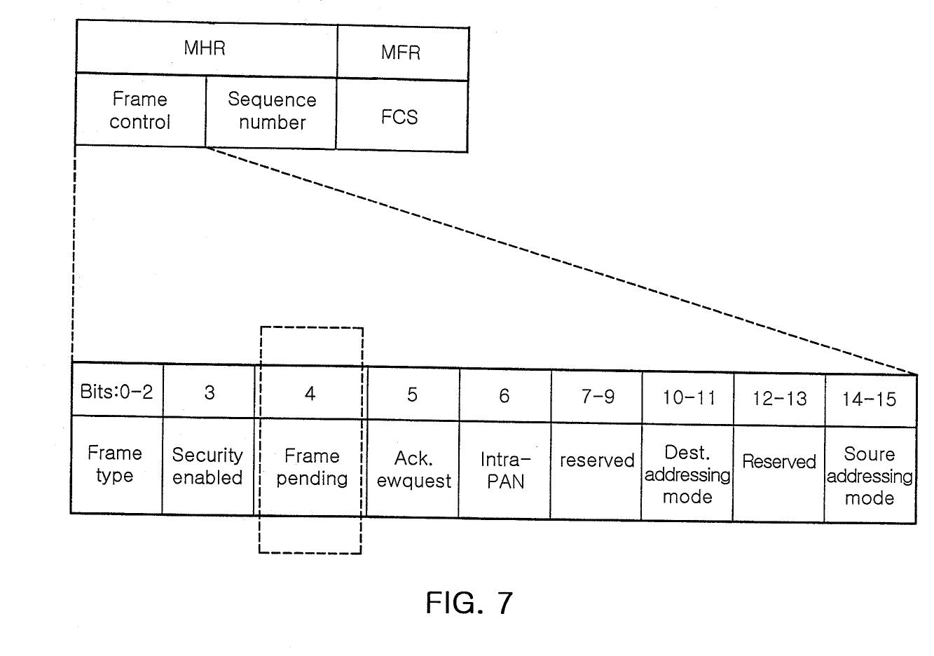

FIG. 7 is a block diagram illustrating a configuration of an acknowledge frame used in an exemplary embodiment of the present invention.

Referring to FIGS. 6 and 7, the acknowledge frame (“3” of FIG. 6) transmitted from the MAC layer of the ZigBee coordinator to the MAC layer of the ZigBee device may be composed of a MAC header (MHR) and a MAC footer (MFR).

The MAC header (MHR) includes a 2 byte size frame control field and a 1 byte size sequence number field.

Each bit in the frame control field is configured so that it can provide various functions, and, among them, a frame pending bit is used to indicate whether data is transmitted. The frame pending bit has a bit size of 1, and therefore it is set to a bit value of “1” in the presence of data to be transmitted, and set to a bit value of “0” in the absence of data to be transmitted.

Referring to FIG. 6, the MAC layer of the ZigBee coordinator transmits to the network layer an Mcps Data Indication command indicating the data transmission, and the MAC layer of the ZigBee device downloading the acknowledge frame transmits to the network layer an Mcps Data Confirm command indicating the presence of data to be downloaded (S310 of FIG. 4).

After the above-mentioned command transmission time (transmission delay time T), the ZigBee device transmits a data request frame for requesting data to the ZigBee coordinator (S320 of FIG. 4, “4” of FIG. 6).

Next, the ZigBee coordinator downloading the data request frame transmits an acknowledge frame to the ZigBee device (“5” of FIG. 6), and then transmits its corresponding data to the ZigBee device (S400 of FIG. 4, “6” of FIG. 6). Then, the ZigBee device transmits an acknowledge frame indicating the downloading of the data to the ZigBee coordinator (“7” of FIG. 6).

Finally, the MAC layer of the ZigBee device transmits to the network layer an Mcps Data Indication command indicating the data transmission, and the MAC layer of the ZigBee coordinator downloading the acknowledge frame transmits to the network layer an Mcps Data Confirm command indicating that the data transmission is completed.

Then, the above-mentioned operations are repeated when data continues to be transmitted.

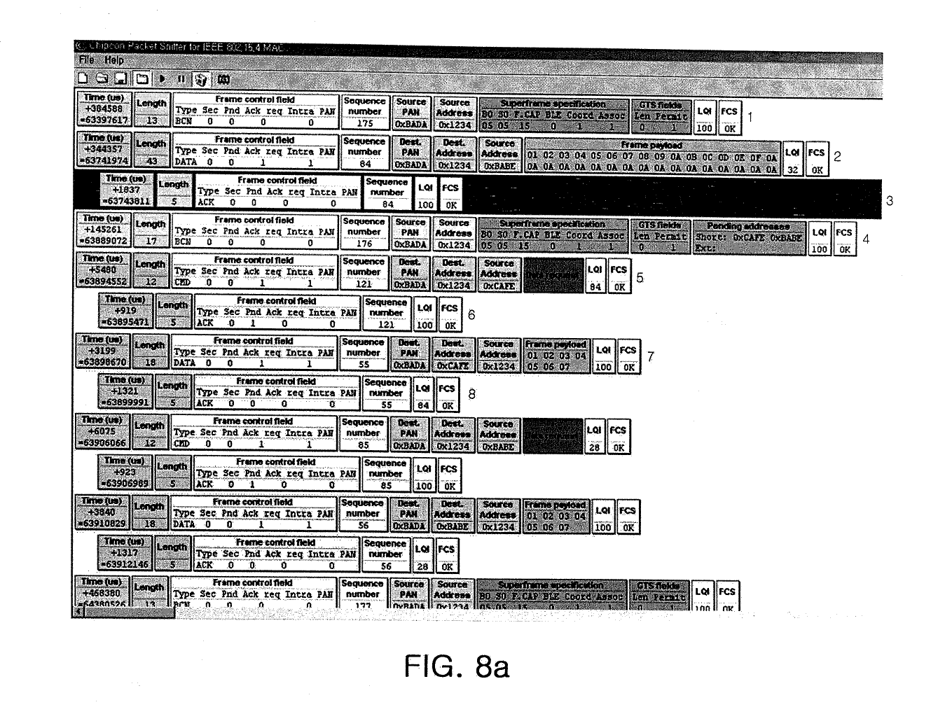

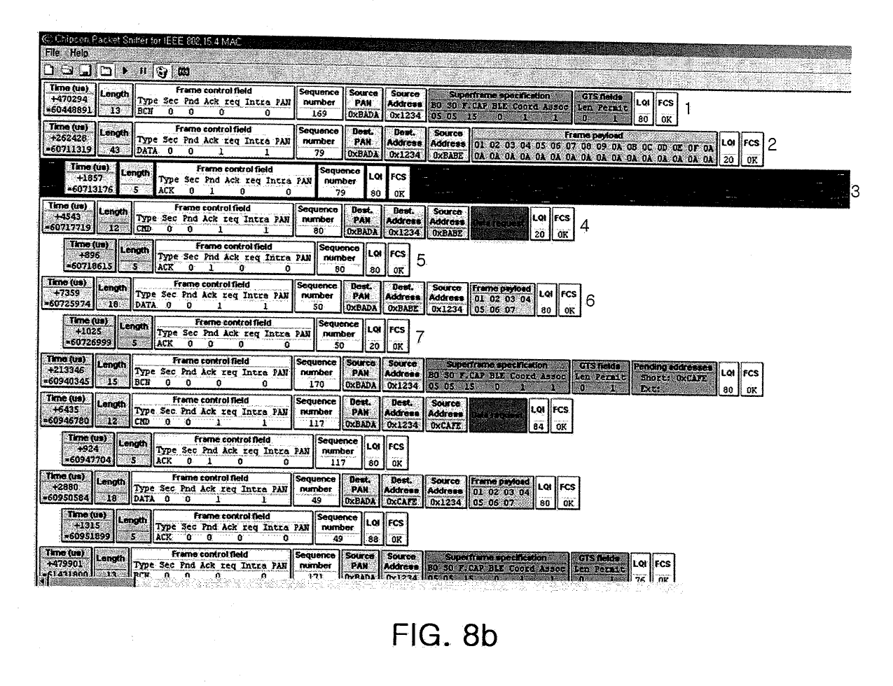

FIG. 8A is a block diagram illustrating a transmission/reception packet that is simulated and captured according to the conventional data transmission method, and FIG. 8B is a block diagram illustrating a transmission/reception packet that is simulated and captured according to the data transmission method of the present invention.

Referring to FIG. 8A, the transmission of a beacon, data frame, an acknowledge frame, a data request frame and the like is repeated totally 8 times to transmit a data to a corresponding ZigBee device, but, referring to FIG. 8B, the transmission of a beacon, a data frame, an acknowledge frame, a data request frame and the like is repeated totally 7 times to transmit a data to a corresponding ZigBee device. Therefore, a data transmission time may be shortened, and particularly, a delay time for data transmission may be shortened since the acknowledge frame may be used to indicate whether or not a data is transmitted.

As described above, the data transmission method according to the present invention can be useful to shorten a delay time for data transmission by previously indicating that a data to be transmitted to the ZigBee device remains by using a certain bit in the acknowledge frame, which leads to the shortened data transmission time.

While the present invention has been shown and described in connection with the exemplary embodiments, it will be apparent to those skilled in the art that modifications and variations can be made without departing from the spirit and scope of the invention as defined by the appended claims.

What is claimed is:

1. A data transmission method indicating data pending in a ZigBee network, the data transmission method being used in a ZigBee network including a ZigBee coordinator and at least one ZigBee device connected to the ZigBee coordinator, the data transmission method comprising:
broadcasting beacons to allow the ZigBee coordinator maintain the connection of the ZigBee network;
downloading a data frame from an assigned ZigBee device transmitting the data frame by receiving the beacons; and
transmitting an acknowledge frame including a data pending bit indicating data pending to the assigned ZigBee device.

2. The data transmission method of claim 1, further comprising downloading a data request frame for requesting data transmission from the assigned ZigBee device and transmitting a data to be transmitted to the assigned ZigBee device when the data to be transmitted to the assigned ZigBee device remains in the ZigBee coordinator.

3. The data transmission method of claim 1, wherein the acknowledge frame includes a header having a frame control field, and the frame control field includes the data pending bit.

4. The data transmission method of claim 1, wherein the data frame indicates the downloading of the beacons for the connection of the ZigBee network.

5. The data transmission method of claim 1, wherein the data frame includes an acknowledge information indicating the downloading of the beacons for the connection of the ZigBee network; and an operation information performing an operation in the ZigBee coordinator to perform a predetermined operation by request of external users.

6. The data transmission method of claim 3, wherein the data pending bit is a frame pending bit, and the frame pending bit is set to a bit value of “1” when a data to be transmitted remains in the ZigBee coordinator and set to a bit value of “0” when a data to be transmitted does not remain.
